(19) United States
(12) Patent Application Publication
(10) Pub. No.: US 2005/0011377 A1
(43) Pub. Date: Jan. 20, 2005

(54) Methods and systems for providing an image on an organic product

(76) Inventors: Roland N. Walker, Idaho Falls, ID (US); Rene Rodriguez, Bountiful, VT (US)

Correspondence Address: KIRTON & McCONKIE;1800 Eagle Gate Tower, 60 East South Temple, Salt Lake City, UT, 84111, US

(21) Appl. No.: 10/672,415

(22) Filed: Sep. 27, 2004

Related U.S. Application Data
(62) Division of application No. 09/964,989, filed on Sep. 26, 2001.

(51) Int. Cl. B41F 17/00

(52) U.S. Cl. 101/41

(57) ABSTRACT

Systems and methods for providing an image on an organic product to provide a communication to the recipient or otherwise individualize the organic product. The image is photo-etched into a photosensitive material of a printing plane or cliché by the use of a film positive. Ink is applied to the cliché and a transfer medium is placed in contact with the cliché. The transfer medium lifts ink from the image area of the cliché and creates a negative image on the medium. The transfer medium transfers the inked image onto an organic product, such as a flower petal or leaf. The printed image is then set so as to remain on the organic product to communicate a message to and/or to individualize the product for the intended recipient.

### BACKGROUND OF THE INVENTION

1. Field of the Invention

The present invention relates to systems and methods for providing an image on an item. More particular, the present invention relates to systems and methods for providing an image, such as one or more characters, symbols, pictures and/or designs, onto an organic product, such as a plant, flower, fruit or portion thereof.

2. Background and Related Art

Organic products, such as flowers and fruit, are commonly exchanged as gifts for a variety of reasons. For example, flowers are given to celebrate such occasions as anniversaries, birthdays, graduations, promotions, retirements, and other meaningful events. Flowers have also been used to express feelings of appreciation, friendship, love, romance, and sympathy. Similarly, fruit and/or other organic products have been packaged into gift baskets and exchanged as holiday gifts.

When an organic product is delivered as a gift to the intended recipient, a card that is written by the purchaser or by another individual on behalf of the purchaser typically accompanies the gift. For example, a purchaser may contact a local florist to place an order for one or more flowers that are to be given as a gift to a particular recipient. The purchaser may receive the flowers and deliver them personally or may allow the florist to deliver the flowers to the intended recipient on behalf of the purchaser. When the purchaser is present at the local floral shop, the purchaser may express his/her feelings on a card that will accompany the delivery of the flowers. Alternatively, when not in person at the floral shop, an employee of the shop may prepare a card on behalf of the purchaser that will accompany the flowers when delivered and that expresses the sentiments of the purchaser.

While the flowers provide a gift to the recipient, it is the card that is the medium used to communicate a particular message or expression from the purchaser to the recipient. When the flowers are delivered without a card, the recipient is required to interpret the meaning of the gift, which can result in an erroneous conclusion.

### SUMMARY OF THE INVENTION

The present invention relates to systems and methods for providing an image on an item. More particular, the present invention relates to systems and methods for providing an image, such as one or more characters, symbols, pictures and/or designs, onto an organic product, such as a plant, flower, fruit or portion thereof.

Implementation of the present invention takes place in association with at least a portion of an organic product, such as a portion of a flower, plant, or fruit. An image is provided and printed on the portion of the organic product to provide a communication to the recipient. The image may include feelings of expression, such as the words “I Love You,” “Congratulations,” “Thank You,” “I'm Sorry,” “Merry Christmas,” or “Happy Birthday.” Alternatively, the image may be a logo of a company and optionally may include a particular number of years that the recipient has worked for the company. As such, the printing on the organic product individualizes the product.

In one implementation, the image that is to be printed onto an organic product, such as a flower, is photo-etched into a photosensitive material of a cliché, such as a printing plate or plane, by the use of a film positive. Ink is then applied to the cliché and a transfer medium is pressed onto the cliché in order to lift ink from the image area of the cliché and create a negative image on the transfer medium. The medium is used to transfer the inked image onto an organic product, such as a flower petal or leaf. The transferred image is then allowed to dry so as to remain on the flower petal or leaf and may be used to communicate a message to and/or individualize the gift for the intended recipient.

While the methods and processes of the present invention are particularly useful in the floricultural industry, those skilled in the art can appreciate that the methods and processes can be used in a variety of different applications and in a variety of different areas of manufacture to yield printing on organic products or on portions thereof.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 provides an illustration of a representative image that is created on a cliché in preparation for providing the image onto an organic product;

FIG. 2 provides a representative press that may be used to create an image that is a negative to the image created in the cliché;

FIG. 3 provides an illustration of the negative image being transferred from the transfer medium to an organic product;

FIG. 4 illustrates a flow chart that provides a representative method for providing an image on an organic product; and

FIG. 5 provides an example of one or more organic products having an image placed thereon in accordance with the present invention.

### DETAILED DESCRIPTION OF THE INVENTION

The present invention relates to systems and methods for providing an image on an item. More particular, the present invention relates to systems and methods for providing an image, such as one or more characters, symbols, pictures and/or designs, onto an organic product, such as a plant, flower, fruit or portion thereof.

In the disclosure and in the claims the term “organic product” shall refer to “an item of nature or a portion thereof. Examples of organic products include one or more kinds of fruit, flowers, plants, leaves, stems, petals or other natural items that may be used in accordance with the present invention for receiving an image thereon. Furthermore, in the disclosure and in the claims the term “image” shall refer to a visual representation that may be provided onto an organic product. Examples of images include one or more characters (e.g. letters, numbers, or other characters), logos, pictures, symbols, illustrations, designs, icons, emblems, trademarks, other representations, and any combination thereof.

Embodiments of the present invention embrace providing one or more images onto at least a portion of an organic product. The images are provided onto the portion of the organic product to provide a communication to the recipient and/or to individualize the product. The image may include feelings of expression, such as the words “I Love You,” “Congratulations,” “Thank You,” “I'm Sorry,” “Merry Christmas,” or “Happy Birthday.” Alternatively, the image may be a logo of a company and optionally may include a particular number of years that the recipient has worked for the company.

The image may be provided onto an organic product in a variety of manners. For example, the image may be printed, painted, sprayed, copied, transferred, etched, embossed, engraved, scratched, stamped, cut, imprinted, scored, embossed, carved or otherwise marked into at least a portion of an organic product.

With reference to FIGS. 1-4, an embodiment of the present invention is illustrated as a representative method for providing an image onto an organic product. In the method, an image is transferred onto an organic product through the use of a transfer printing technique.

In FIG. 1, a cliché, illustrated as plate 10, is provided that includes a photosensitive material 12. While FIG. 1 illustrates the cliché as a plate, other clichés may be used such as a printing plane or other surface that allows an image to be etched therein.

In the present embodiment, an image is etched into the photosensitive material by taking a copy of an image and creating a film positive of the image. (The film positive is the image on clear film.) Once the film positive is created, the photosensitive material of plate 10 is exposed through a wash out process in order to form the etched image 14 in the photosensitive material 12 of plate 10.

FIG. 1 illustrates containers 16, which are used to house ink (not shown). By way of example, container 16a may house one type of ink, such as black ink, and container 16b may house another type of ink, such as gold ink. Once the etched image 14 is created, ink is applied to the plate 10 so as to fill the etched image 14 on plate 10. A blade 18 is used to spread the ink so as to fill the etched image 14 with ink and to remove any excess ink from the plate 10.

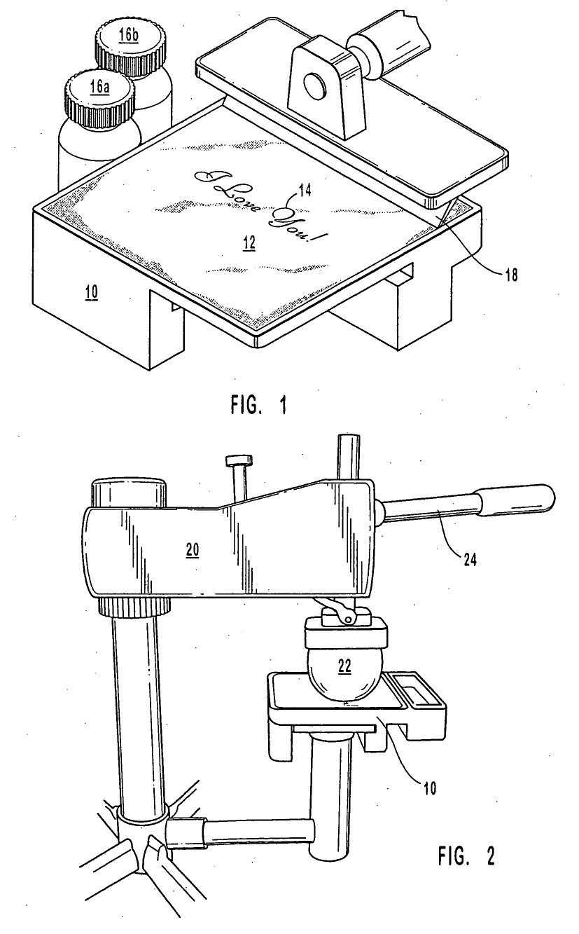

In FIG. 2, plate 10 is coupled to a mechanical press 20, which includes a transfer medium, illustrated as pad 22, and a lever 24. Plate 10 may be selectively coupled to press 20 so that the process of creating the etched image 14 is performed prior to coupling plate 10 to press 20. This further allows for the use of a plurality of removable plates that may be selectively used in association with press 20, wherein each plate includes a different image etched thereon.

As a user of press 20 pulls lever 24 in a downward direction, pad 22 lowers and is placed in contact with the surface of plate 10. Similarly, as the user releases or lifts in an upward direction, lever 24 is raised so as to no longer be in contact with plate 10. The process of lowering pad 22 so as to contact plate 10 and of raising pad 22 causes ink to be lifted from the etched image 14 of FIG. 1 so as to create a negative of the image on pad 22.

In one embodiment, pad 22 swivels to facilitate a transfer of the image onto an organic product. In another embodiment, pad 22 is selectively removed by the user from mechanical press 20 of FIG. 2 so as to transfer the image onto an organic product.

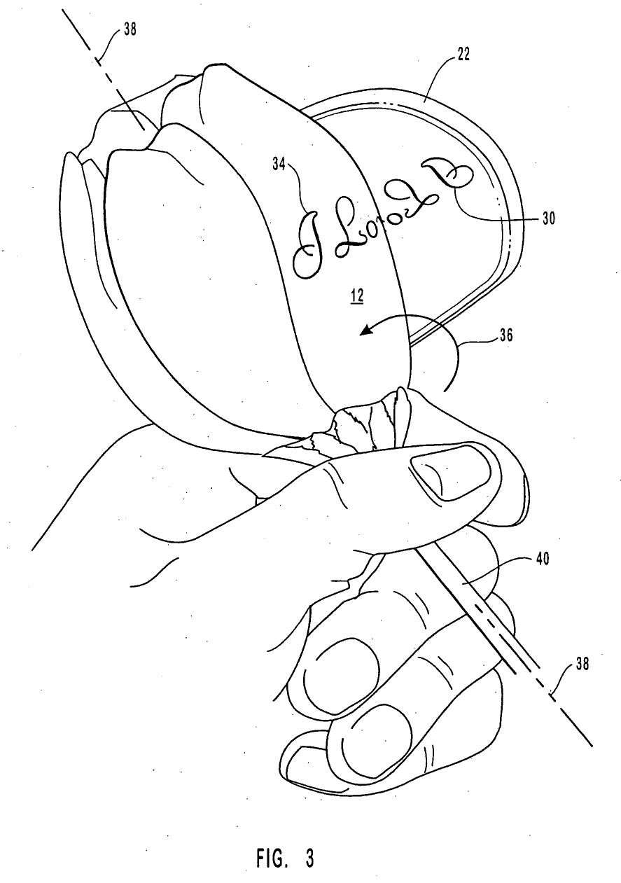

With reference to FIG. 3, a portion of the surface of pad 22 is illustrated that includes the created negative image, illustrated as negative image 30. An organic product, such as flower petal 32, is placed in contact with negative image 30 to provide the image 34 on flower petal 32. In one embodiment, and as illustrated by arrow 36, the organic product is placed in contact with the surface of pad 22 to transfer a clean print of image 34 onto the organic product, such as flower petal 32. While the printed image 34 illustrated in FIG. 3 is located transverse to the central axis 38 of flower 40, the image may be transferred to any location of petal 32 with relation to axis 38. Furthermore, a plurality of images may be transferred onto flower 40.

While the transfer medium illustrated in FIGS. 2 and 3 is a pad, other transfer media may be used in the transfer printing technique, such as a roller or other transfer medium. It is the purpose of the transfer medium to transfer the image from a plate or printing plane, often referred to as a cliché, to a surface or substrate of the organic product.

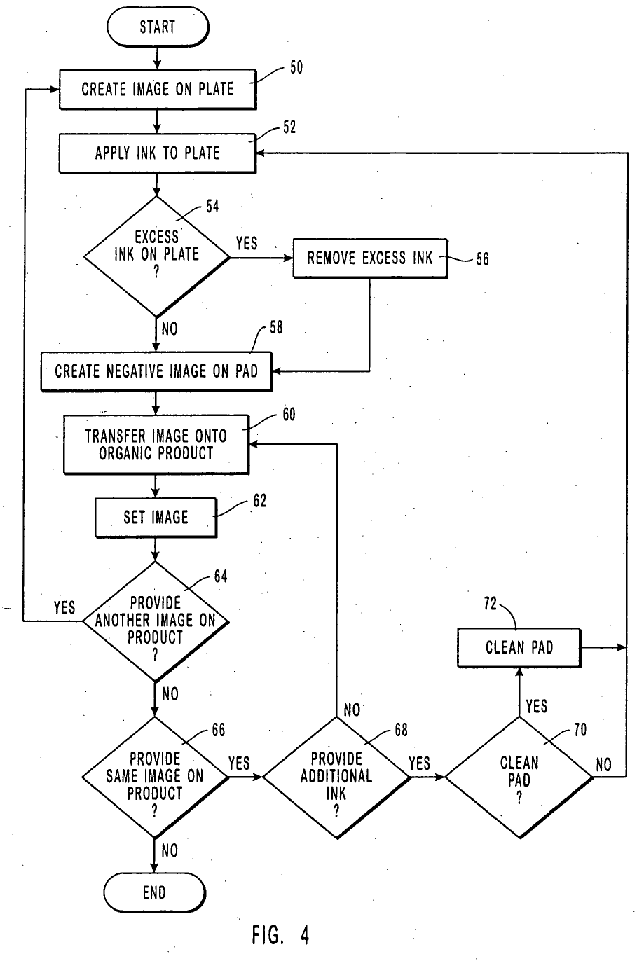

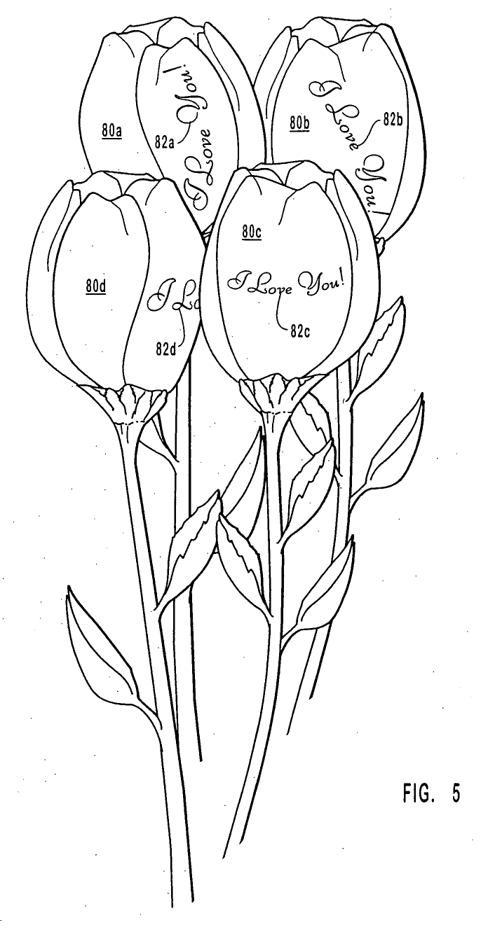

With reference to FIG. 4, a flow chart illustrates a representative method used in accordance with the present invention to provide an image on an organic product. In FIG. 4, execution begins at step 50, where an image is created on a cliché, such as plate 10 of FIG. 1. One manner for creating the image, as provided above, is by etching the image into a photosensitive material of the plate, which is done by taking a copy of an image and creating a film positive of the image. Once the film positive is created, the photosensitive material of the plate is exposed through a wash out process in order to form the etched image into the photosensitive material of the plate. Execution then proceeds to step 52.

At step 52, ink is applied to the cliché or plate. The ink is applied so as to fill the image created at step 50. A determination is then made at decision block 54 as to whether or not excess ink is located on the plate. If it is determined at decision block 54 that no excess ink is located on the plate, execution proceeds to step 58. However, if it is determined at decision block 54 that excess ink is located on the plate, execution proceeds to step 56, where the excess ink is removed. As provided above, one manner of removing the excess ink is by utilizing a blade, such as blade 18 of FIG. 1. Once the excess ink is removed, execution proceeds to step 58.

At step 58 a negative image is created on a transfer medium, such as pad 22 of FIG. 2. The negative image is created, for example, by causing a transfer medium or pad to be placed in contact with the inked image on the plate. The pad lifts ink from the pad so as to create a negative image on the pad. At step 60 the image is then transferred onto an organic product. This may be performed, for example, by rolling the surface of the pad that includes the negative image onto the surface of an organic product. Execution then proceeds to step 62, where the image on the organic product is set, such as by allowing the printed image to dry.

At decision block 64 a decision is made as to whether or not to provide another image on the product. At times it is advantageous to place a first image at a first location of an organic product and a second image at a second location of the product. Alternatively, it is advantageous to place a first image in a first color (e.g. black) at a first location and a second image, which is similar to the first image except more narrow, in a second color (e.g. gold) on top of the first image. Therefore, the combination of the two images provides the appearance of a single image that is gold with a black border.

Thus, if it is determined at decision block 64 that another image is to be provided on the product, execution returns back to step 50, where the subsequent image is created. The subsequent image may be the same image that is prepared with a different ink or may be an entirely different image. The ink is applied to the subsequent image at step 52 and a determination is made at decision block 54 as to whether or not any excess ink is located on the plate. If excess ink is present, it is removed at step 56, otherwise execution proceeds to step 58 for the creation of a negative of the subsequent image on a pad. The image is transferred onto the organic product at step 60 and is set at step 62. A determination is then made at decision block 64 as to whether or not to apply or provide another image onto the organic product. If yet another image is to be provided, execution returns again to step 50.

Once it is determined at decision block 64 that another image is not to be provided, execution proceeds to decision block 66 for a determination as to whether or not the same image is to be provided onto another organic product. If it is determined that the same image is to be provided onto another organic product, execution proceeds to decision block 68 for a determination as to whether or not to provide additional ink to the transfer medium or pad. If it is determined that no additional ink is needed on the pad, execution returns to step 60, where the image is transferred onto the other organic product and is allowed to set. If another image is to be provided on the other product, execution returns back to step 50.

Returning back to decision block 68, if it is determined that additional ink is needed to transfer the image onto another product, execution proceeds to decision block 70 for a determination as to whether or not to clean the transfer medium or pad. If it is determined that the pad does not need to be cleaned execution returns back to step 52. Alternatively, if it is determined that the pad needs to be cleaned, execution proceeds to step 72, where the pad is cleaned, and then to step 52, where additional ink is applied to the plate. Any excess ink is removed at step 56, a negative is created on the pad at step 58, the image is transferred onto the organic product at step 60, and the image is set at step 62.

With reference to FIG. 5, an illustration is provided of organic products 80 that have images 82 thereon that may be used to communicate a message to an intended recipient or otherwise individualize the organic products for the recipient. As illustrated by images 82, the image may be provided in a variety of directions with respect to the central axis of a particular organic product 80. Furthermore, while the methods and processes of the present invention are particularly useful in the floricultural industry, those skilled in the art will appreciate that the methods and processes can be used in a variety of different applications and in a variety of different areas of manufacture to yield printing on organic products or portions thereof.

Thus, as discussed herein, the embodiments of the present invention embrace systems and methods for providing an image on an item. More particular, the present invention relates to systems and methods for providing an image, such as one or more characters, symbols, pictures and/or designs, onto an organic product, such as a plant, flower, fruit or portion thereof.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for providing an image on an organic product, the method comprising the steps for:
creating an image on a transfer medium; and
transferring the image onto an organic product.

2. The method as recited in claim 1, wherein the step for creating an image comprises the steps for:
creating a first image on a cliché;
applying ink to the cliché; and
lifting at least a portion of the ink from the cliché to form a second image, wherein the second image is the image created on the transfer medium.

3. A method as recited in claim 2, wherein the step for lifting comprises the steps for:
placing the transfer medium in contact with the cliché; and
removing the transfer medium from the cliché.

4. A method as recited in claim 2, wherein the step for creating further comprises the step for removing excess ink applied to the cliché.

5. A method as recited in claim 2, wherein the step for creating a first image comprises the step for etching the first image into the cliché.

6. A method as recited in claim 5, wherein the cliché comprises a photosensitive material.

7. A method as recited in claim 6, wherein step for etching comprises the steps for:
providing a third image;
creating a film positive of the third image; and
exposing the photosensitive material through a wash out process to etch the third image into the photosensitive material.

8. A method as recited in claim 1, further comprising the step for allowing the transferred image to set.

9. A method as recited in claim 1, wherein the organic product comprises at least a portion of:
(i) a flower;
(ii) a fruit; or
(iii) a plant.

10. A method as recited in claim 1, wherein the image transferred onto the organic product comprises at least one of:
(i) a character;
(ii) a number;
(iii) a logo;
(iv) a picture;
(v) a symbol;
(vi) a design;
(vii) an icon; or
(viii) a trademark.

11. (Canceled)

12. (Canceled)

13. (Canceled)

14. (Canceled)

15. (Canceled)

16. A system for providing an image on an organic product, the system comprising:
a portion of an organic product;
a transfer medium; and
an image, wherein the image is located on a portion of the transfer medium and is used to provide a transferred image onto the organic product.

17. A system as recited in claim 16, wherein the organic product is a flower.

18. A system as recite in claim 17, wherein the portion is one of:
(i) a petal; or
(ii) a leaf.

19. A system as recited in claim 16, further comprising a cliché, wherein the cliché includes an etched image that is at least partially filled with ink to place the image on the portion of the transfer medium

20. A system as recited in claim 19, wherein the cliché includes a plate, and wherein the transfer medium includes one of:
(i) a pad; or
(ii) a roller.
